(19) United States
(12) Patent Application Publication
(10) Pub. No.: US 2025/0010905 A1
(43) Pub. Date: Jan. 9, 2025

(54) STROLLER WAGON COVER

(71) Applicant: Erica Eshe Berner, McKinney, TX (US)

(72) Inventor: Erica Eshe Berner, McKinney, TX (US)

(21) Appl. No.: 18/892,690

(22) Filed: Sep. 23, 2024

Related U.S. Application Data
(60) Provisional application No. 63/559,817, filed on Feb. 29, 2024.

(51) Int. Cl. B62B 9/14

(52) U.S. Cl. CPC B62B 9/142

(57) ABSTRACT

Stroller wagons are widely used for a variety of reasons such as storage purposes or for carrying children or used by caregivers for special needs. The multi-functional vehicles are foldable, making them easier to store in vehicles or at home when not in use. However, during loading and unloading process of stroller wagons into the car, it scratches the exterior of the car. The protective covers prevent scratching of the car by means of three layers quilted into each other with a base layer providing anti-slip purpose to prevent the cover from sliding around the wagon frame and the middle layer providing cushioning and with the top layer providing a smooth loading and unloading process. The protective covers are different in length and width for rear wagon frames and front wagon frames and can be customized as per the stroller wagon brands without jeopardizing the protective aspect of the covers.

### BACKGROUND

### 1. Field of the Invention

The present invention relates generally to stroller wagon covers.

### 2. Description of Related Art

Stroller wagons are used for a variety of reasons, combining the benefits of both strollers and wagons to meet the needs of families. It offers a blend of functionality, comfort and convenience making them a popular choice for families who need a versatile and practical solution for transporting children and their belongings or for caregivers as well.

However the stroller wagon frame can inadvertently scratch or dent the car's exterior, especially if the wagon is not lifted carefully and makes contact with the vehicle's body. Repeated loading and unloading can cause wear and tear on the trunk or hatch area. This includes potential damage to the trunk. Improper loading techniques can cause the stroller wagon to shift or fall during transit, potentially causing damage to the car's interior and exterior. Hence, it is essential to use protective covers or guards to prevent scratching of the exterior of the car.

Present solution offers covers that serves as handicap signage and do not have the soft exterior for protection, or grip stop, padding for anti-scratch purposes.

Accordingly, it is an object of the present application to provide an anti-scratch protective cover for stroller wagons and avoid denting and scratching of the car during loading and unloading process.

### BRIEF DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a perspective view of the protective front cover;

FIG. 2 shows measurement of the protective cover in one case;

FIG. 3 is a perspective view of the protective rear cover with openings;

FIG. 4 is a side view of the protective cover wrapped around the stroller wagon frame;

FIG. 5 is an up-close view of the wagon pressing against the car; and

FIG. 6 is side view of loading the stroller wagon inside the car without scratching the bumper.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION

Illustrative cases of the device and method of use of the present application are provided below. It will of course be appreciated that in the development of any actual case, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The device and method of use will be understood, both as to its structure and operation, from the accompanying drawings, taken in conjunction with the accompanying description. Several cases of the system are presented herein. It should be understood that various components, parts, and features of the different cases may be combined together and/or interchanged with one another, all of which are within the scope of the present application, even though not all variations and particular cases are shown in the drawings. It should also be understood that the mixing and matching of features, elements, and/or functions between various cases is expressly contemplated herein so that one of ordinary skill in the art would appreciate from this disclosure that the features, elements, and/or functions of one case may be incorporated into another case as appropriate, unless described otherwise.

The preferred case herein described is not intended to be exhaustive or to limit the invention to the precise form disclosed. It is chosen and described to explain the principles of the invention and its application and practical use to enable others skilled in the art to follow its teachings

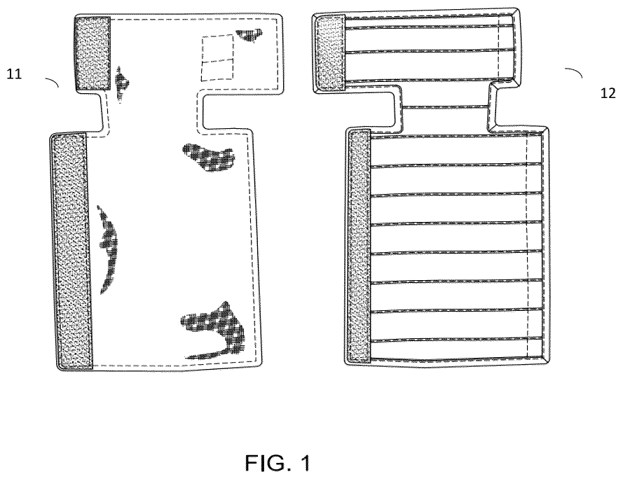

The technology described herein fulfills a stroller wagon cover. As shown in FIG. 1, the stroller wagon covers are configured to be made of a base layer 11, the surface of the base layer configured to be attached to the wagon frame and is slip-resistant preventing the cover to fall off or slide around the wagon frame. A middle layer, that is hidden quilted to the base layer 11 made of at least half an inch foam or a similar material to provide cushion between the wagon frame and the bumper and a top layer 12 quilted to both the base layer and the middle layer made of cotton or a woven fabric to provide smooth loading of the stroller wagon onto an automobile without scratching the bumper.

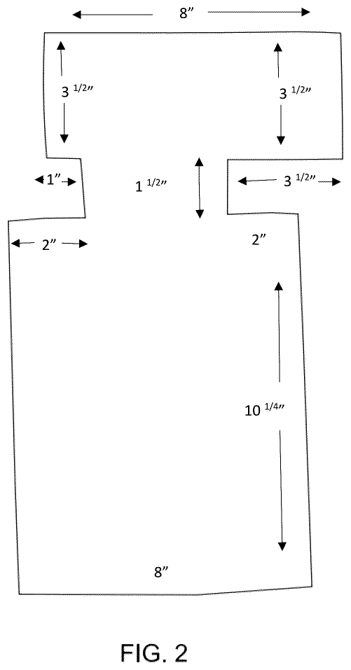

FIG. 2 shows measurement of the protective covers customized to W2, W4 Elite and Luxe stroller wagons. The protective covers can be retrofitted and made for other stroller wagon brands, for example Keenz. The protective covers can also be made with custom fabrics for aesthetically pleasing finishes on the stroller wagon frame, as well as serve as medical signage for special needs wagon user. The custom fabric does not hinder the protective nature of the anti-scratch protective covers with the cotton top layer but with custom printed fabric.

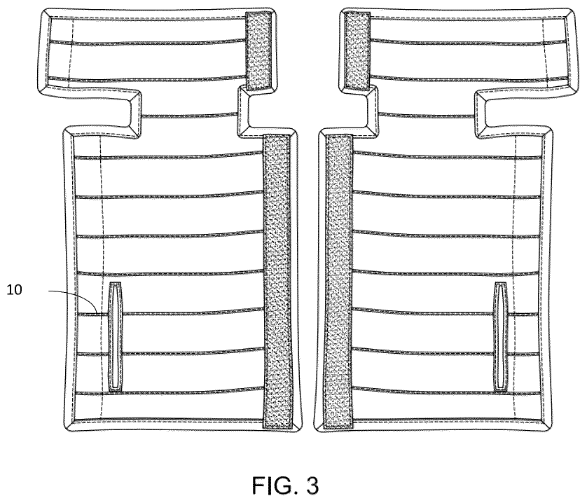

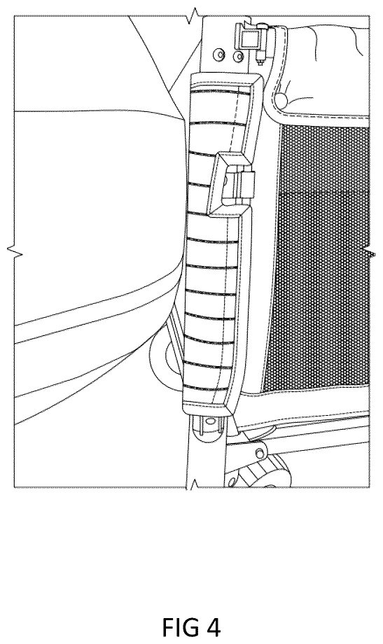

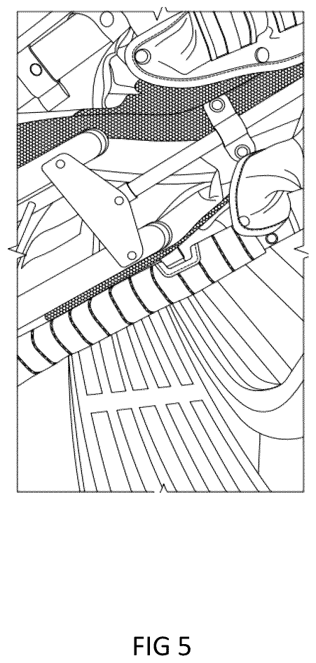

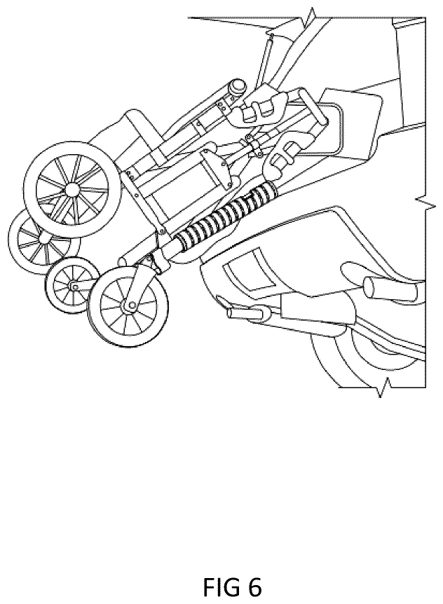

FIG. 3 shows the rear protective covers that are in our preferred case one inch shorter than the front protective cover and has openings 10 to allow rear wagon bracket to pass through. The protective covers are closed with industrial grade Velcro. FIG. 4 shows the protective covers wrapped around the wagon frames with industrial grade Velcro. FIG. 5 shows an up-close view of pressing the wagon to the car and a smooth loading without scratching the bumper of the car and wagon in FIG. 6.

The particular cases disclosed above are illustrative only, as the cases may be modified and practiced in different but equivalent manners apparent to those skilled in the art having the benefit of the teachings herein. It is therefore evident that the particular cases disclosed above may be altered or modified, and all such variations are considered within the scope and spirit of the application. Accordingly, the protection sought herein is as set forth in the description. Although the present cases are shown above, they are not limited to just these cases but are amenable to various changes and modifications without departing from the spirit thereof.

What is claimed is:

1) A protective cover for a stroller wagon comprising:
a base layer configured to be made of a sliding resistant material to avoid sliding around on a wagon frame;
a middle layer configured to provide cushion between the wagon frame and bumper, wherein the middle layer is configured to be quilted to the base layer;
a top layer configured to provide smooth loading of the stroller wagon into an automobile without scratching, wherein the top layer is configured to be made of a woven fabric and is configured to be quilted to the base layer and the middle layer.

2) The protective cover for a stroller wagon of claim 1, wherein the base layer is configured to be made of a semi-sticky rubber to keep the protective cover from sliding around on the wagon frame.

3) The protective cover for a stroller wagon of claim 1, wherein the middle layer is configured to be made of at least half an inch of foam to provide cushion between the wagon frame and the bumper.

4) The protective cover for a stroller wagon of claim 1, wherein the top layer is configured to be made of cotton.

5) The protective cover for a stroller wagon of claim 1, wherein the protective cover is at least one inch shorter for a rear wagon frame than a front wagon frame and is configured to have at least an opening for a rear wagon bracket to pass through.
